(19) United States
(12) Patent Application Publication
(10) Pub. No.: US 2019/0248322 A1
(43) Pub. Date: Aug. 15, 2019

(54) AIRBAG SYSTEMS WITH TETHER PRETENSIONING AND LOAD LIMITING

(71) Applicant: Autoliv ASP, Inc., Ogden, UT (US)

(72) Inventors: Frank Herzenstiel, Davisburg, MI (US); David W. Schneider, Waterford, MI (US)

(21) Appl. No.: 15/894,711

(22) Filed: Feb. 12, 2018

(51) Int. Cl. B60R 21/2338; B60R 21/213; B60R 21/207; B60R 21/214

(52) U.S. Cl. CPC B60R 21/2338; B60R 21/214; B60R 21/207; B60R 21/213

(57) ABSTRACT

Inflatable airbag assemblies are disclosed. The airbag assemblies can include a housing, an inflator assembly, an inflatable cushion, a tether, and a tension control mechanism. The tension control mechanism can include a pretensioning retractor and a load limiting member. The pretension retractor can be configured to apply a retracting tension or load to the tether following deployment of the inflatable cushion. The load limiting member can be configured to control extension of the tether during ride down of the inflatable cushion by applying a load or drag force to the tether.

### TECHNICAL FIELD

The present disclosure relates generally to the field of automotive protective systems. More specifically, the present disclosure relates to tethered airbag systems with pretensioning and load limiting members that are configured to deploy in response to collision events.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments and are, therefore, not to be considered limiting of the scope of the disclosure, the embodiments will be described and explained with specificity and detail in reference to the accompanying drawings.

FIG. 1A is a side elevation view of an airbag assembly, according to one embodiment of the present disclosure, in a deployed state within a vehicle.

FIG. 1B is a front elevation view of the airbag assembly of FIG. 1A in a deployed state.

FIG. 2A is a side elevation view of the airbag assembly of FIG. 1A in a packaged state.

FIG. 2B is a side elevation view of the airbag assembly of FIG. 1A in a partially deployed state during a vehicle impact event.

FIG. 2C is a side elevation view of the airbag assembly of FIG. 1A, in a deployed state.

FIG. 2D is a side elevation view of the airbag assembly of FIG. 1A, in a deployed state with pretensioning of a tether.

FIG. 2E is a side elevation view of the airbag assembly of FIG. 1A, in a ride down state with load limiting extension of the tether.

FIG. 3A is a side elevation view of an airbag assembly, according to another embodiment of the present disclosure, in a packaged state.

FIG. 3B is a side elevation view of the airbag assembly of FIG. 3A, in a deployed state.

FIG. 3C is a side elevation view of the airbag assembly of FIG. 3A, in a deployed state with pretensioning of a tether.

FIG. 3D is a side elevation view of the airbag assembly of FIG. 3A, in ride down state with load limiting extension of the tether.

FIG. 4 is a side elevation view of an airbag assembly, according to another embodiment of the present disclosure, in a deployed state.

FIG. 5 is a side elevation view of an airbag assembly, according to another embodiment of the present disclosure, in a deployed state.

FIG. 6 is a side elevation view of an airbag assembly, according to another embodiment of the present disclosure, in a deployed state.

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

Inflatable airbag assemblies are widely used to reduce or minimize occupant injury during a collision event. Airbag modules have been installed at various locations within a vehicle, including, but not limited to, in the steering wheel, in the dashboard and/or instrument panel, within the side doors or seats, adjacent to a roof rail of the vehicle, in an overhead position, or at the knee or leg position. In the following disclosure, “airbag” generally refers to an inflatable airbag or cushion that deploys from an overhead position (or from a position generally over a vehicle occupant position) or from in a seat position to protect an occupant during a collision event. The disclosed airbag assemblies and airbag embodiments may be utilized in place of or in conjunction with other airbags, such as, for example, a front passenger airbag that is typically housed within the dashboard, driver airbags housed within the steering wheel, knee airbags, and side airbags. The disclosed airbag assemblies may also be used in conjunction with one or more of the rear seats of a vehicle (e.g., in an overhead position such as in a seat- or roof-mounted configuration). Further, the disclosed airbag assemblies may be used in an autonomous vehicle (e.g., in a vehicle that may not have a steering wheel and/or that may have limited, or no, reaction surface such as an instrument panel).

As used herein, the terms “dashboard” and “instrument panel” refer to a protruding region of a vehicle faced by a motor vehicle occupant, which often includes a glove compartment in a portion thereof that faces a passenger and may include instruments (e.g., radio and/or climate controls) in a more central region thereof, although such instruments need not be present.

The term “opposite” is a relational term used herein to refer to a placement of a particular feature or component in a position corresponding to another related feature or component wherein the corresponding features or components are positionally juxtaposed to each other. By way of example, a person's right hand is opposite the person's left hand. An “inboard” component may be situated opposite an “outboard” component.

The term “void” as used herein refers to a volume of space enclosed within the walls of a containing chamber. The containing chamber, or the walls thereof, may be fixed or flexible; hence, the volume of the space enclosed may also be fixed or flexible. For example, an airbag cushion may consist of fabric walls intended to contain a volume of inflation gases within the space between the walls.

The terms “proximal” and “distal” are directional terms used herein to refer to opposite or approximately opposite locations on an airbag cushion. The proximal end or proximal portion of an airbag cushion is the end or portion of the airbag cushion that is nearer the inflator assembly or, in some instances, the housing when the airbag cushion is fully inflated. The distal end or portion is the end or portion of the airbag cushion opposite the proximal end or portion of the airbag cushion, or an end or portion more distant from the inflator assembly or housing than the proximal end or portion. In other words, the terms “proximal” and “distal” are with reference to a point of attachment, such as a point of attachment of the airbag cushion at an airbag assembly housing, and/or a point of attachment of an airbag assembly at a seat back from which an airbag deploys. Specifically, “proximal” is situated toward such point of attachment, and “distal” is situated away from such point of attachment.

The terms “connect” and “coupled to” are used in their ordinary sense, and are broad enough to refer to any suitable coupling or other form of interaction between two or more entities, including mechanical and fluid interaction. Two components may be coupled to each other even though they are not in direct contact with each other. The phrase “attached to” refers to interaction between two or more entities that are in direct contact with each other and/or are separated from each other only by a fastener of any suitable variety (e.g., mounting hardware or an adhesive). The phrase “fluid communication” is used in its ordinary sense, and is broad enough to refer to arrangements in which a fluid (e.g., a gas or a liquid) can flow from one element to another element when the elements are in fluid communication with each other.

During installation, the disclosed airbags are typically disposed at an interior of a housing in a packaged state (e.g., are rolled, folded, and/or otherwise compressed) or a compact configuration and may be retained in the packaged state behind a cover. During a collision event, an inflator assembly is triggered, which rapidly fills the airbag with inflation gas. The airbag can rapidly transition from a packaged state (e.g., a compact configuration) to a deployed state or an expanded configuration. For example, the expanding airbag can open an airbag cover (e.g., by tearing through a burst seam or opening a door-like structure) to exit the housing. The inflator assembly may be triggered by any suitable device or system, and the triggering may be in response to and/or influenced by one or more vehicle sensors.

The term “seat,” as used herein, refers to a structure within the cabin of a vehicle installed such that an occupant may be seated thereon/therein for transport within the vehicle.

The term “front seat,” as used herein, refers to any seat that is disposed immediately rearward of the instrument panel, regardless of whether disposed to either side of the vehicle, and which is disposed forward of any “back seat(s)” (defined below) which may be present in the vehicle.

The term “back seat,” as used herein, refers to any seat that is disposed rearward of the front seat(s) of a vehicle, regardless of whether the seat is the most rearward seat in the vehicle. The term “back seat” also refers to any seat that is disposed rearward of other back seats.

The term “vehicle” may refer to any vehicle, such as a car, truck, bus, airplane, etc.

The phrase “ride down” as used in this disclosure bears the ordinary meaning of the words relative to inflatable airbag systems. That is, ride down typically involves an occupant in contact with an inflatable airbag cushion for some period of time during which the inflatable airbag cushion may support and nominally protect to some degree the occupant from impact(s) with some structure(s)/component(s) of a vehicle, and during which the inflatable airbag cushion may partially deflate to ameliorate deceleration forces.

The phrase “fluid communication” is used in its ordinary sense, and is broad enough to refer to arrangements in which a fluid (e.g., a gas or a liquid) can flow from one element to another element when the elements are in fluid communication with each other.

The terms “a” and “an” can be described as one, but not limited to one. For example, although the disclosure may recite an airbag having “a chamber,” the disclosure also contemplates that the airbag can have two or more chambers.

As used herein, the terms “forward” and “rearward” are used with reference to the front and back of the relevant vehicle. For example, an airbag cushion that deploys in a rearward direction deploys toward the back of a vehicle. Furthermore, other reference terms, such as “horizontal,” are used relative to a vehicle in which an airbag assembly is installed, unless it is clear from context that a different reference frame is intended. Thus, a term such as “horizontal” is used relative to the vehicle, whether or not the vehicle itself is oriented horizontally (e.g., is positioned upright on level ground) or angled relative to true horizontal (e.g., is positioned on a hill).

The phrases “vehicle occupant position” and “vehicle seating position” may be used interchangeably herein and refer to a position in which an occupant is generally positioned when seated in a seat of a vehicle. The term “occupant” refers to a person or crash test dummy within a vehicle.

Certain embodiments of airbag assemblies that are disclosed herein are particularly well suited for cushioning a front-seat passenger, and may be mounted in a roof of a vehicle, or in a structure above a vehicle seating position, or within a seat-back portion of an occupant seat, or with any other suitable vehicle structure, such as a door column or B-pillar. An airbag assembly can mitigate injury to an occupant of a vehicle during a collision event by reducing the effect of impact of the occupant against structures (body-structure impact) within the vehicle (such as, e.g., a dashboard or door column).

Some embodiments disclosed herein can provide improved positioning, cushioning, and/or safety to occupants involved in particular types of collisions. For example, some embodiments can be particularly suited to cushion a vehicle driver and/or front-seat passengers seated adjacent the passenger-side door. Examples of types of collisions in which certain embodiments may prove advantageous include one or more of (1) collisions where the struck object fails to engage the structural longitudinal components and/or engine block of the occupant's vehicle, (2) collisions where the impact forces act primarily outside of either the left or right longitudinal beams of the occupant's vehicle, (3) collisions classified under the Collision Deformation Classification scheme as FLEE or FREE, (4) front-impact collisions where the occupant's vehicle strikes no more than 25% of the vehicle width, (5) collisions as specified for the Insurance Institute for Highway Safety (IIHS) small overlap frontal crash test, or (6) collisions as specified for the National Highway Traffic Safety Administration (NHTSA) oblique impact test. The conditions for the IIHS small overlap front crash test and the NHTSA oblique impact test are disclosed in the Insurance Institute for Highway Safety, Small Overlap Frontal Crashworthiness Evaluation Crash Test Protocol (Version II) (December 2012); and Saunders, J., Craig, M., and Parent, D., Moving Deformable Barrier Test Procedure for Evaluating Small Overlap/Oblique Crashes, SAE Int. J. Commer. Veh. 5(1):172-195 (2012). As used herein, the term “oblique” when used to describe a collision (crash, impact, etc.) is intended to encompass any of the foregoing described collisions and any other collisions in which an occupant's direction of travel as a result of the impact includes both a forward direction or component and a lateral direction or component. In the present disclosure, the longitudinal component of an occupant's post-collision trajectory during or after an oblique collision may be oriented in the car-forward direction.

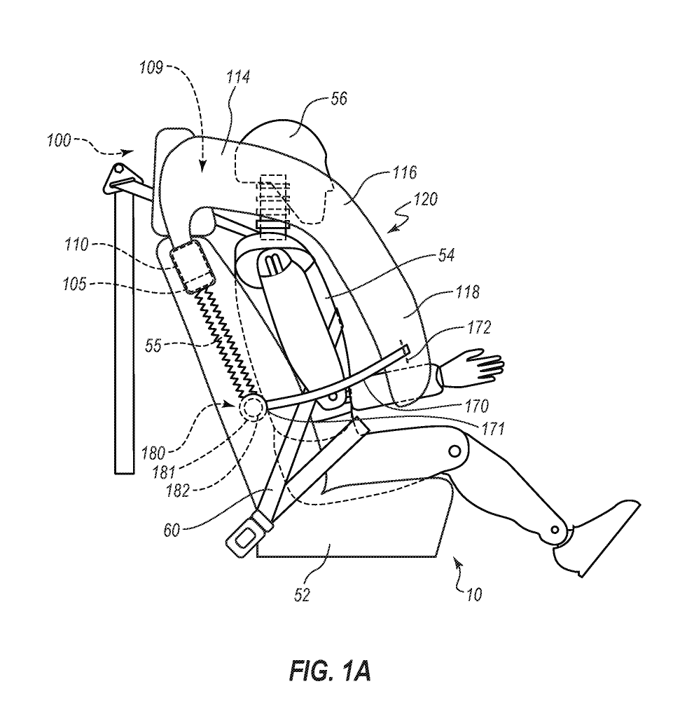

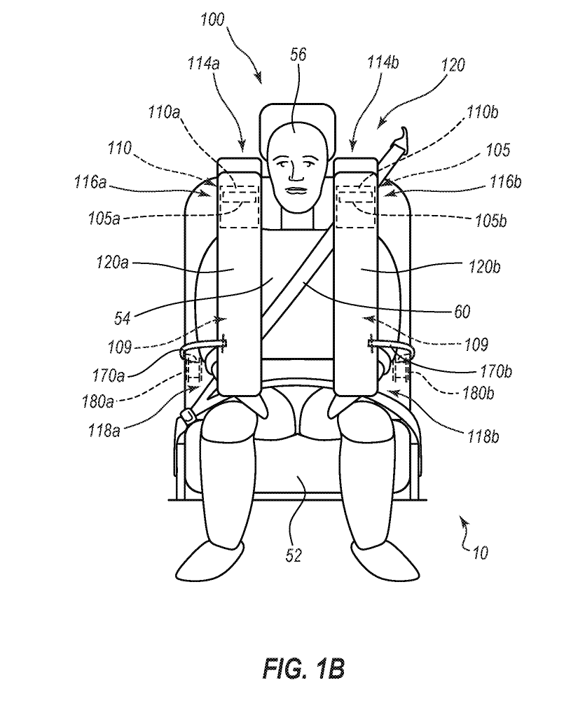

FIGS. 1A-1B depict an embodiment of an inflatable airbag assembly or airbag assembly 100 mounted within a vehicle (not shown). An occupant 54 is positioned on a seat 52 in a vehicle seating position 10. Further, a seatbelt 60 is disposed about the occupant 54. In FIGS. 1A and 1B, the airbag assembly 100 is shown in a deployed configuration or state.

As shown in FIG. 1A, the airbag assembly 100 can include a housing 110, an inflator assembly 105, an inflatable cushion 120 coupled to the housing 110, a tether 170, and a tension control mechanism 180.

As shown in FIG. 1B, the inflatable cushion 120 may include a first lateral chamber 120a and a second lateral chamber 120b. The housing 110 may comprise a first lateral housing portion 110a and a second lateral housing portion 110b. Likewise, the inflator assembly 105 may comprise a first inflator assembly 105a and a second inflator assembly 105b, wherein the first inflator assembly 105a is coupled to the first lateral housing portion 110a, and the second inflator assembly 105b is coupled to the second lateral housing portion 110b.

Additionally, the tether may comprise a first tether 170a and a second tether 170b, wherein an end of the first tether 170a is attached to the first lateral chamber 120a and a first end of the second tether 170b is attached to the second lateral chamber 120b. The tension control mechanism 180 may comprise a first tension control mechanism 180a and a second tension control mechanism, wherein the first tension control mechanism 180a is coupled to an end of the first tether 170a and the second tension control mechanism 180b is coupled to an end of the second tether 170b.

The airbag assembly 100 may be coupled to the seat 52 of the vehicle in any suitable manner. For example, as illustrated in FIGS. 1A-1B, the airbag assembly 100 may be disposed within an upper portion of a back of the seat 52. In other embodiments, the airbag assembly 100 may be coupled to an exterior of the upper portion of the back of the seat 52. The airbag assembly 100 may be independent of or used independently of the seatbelt 60.

The inflatable cushion 120 can define a void 109 that is configured to receive inflation gas (i.e., during a collision event or a vehicle impact event) from the inflator assembly 105 that may expand the inflatable cushion 120 from a packaged state within the housing 110 to a deployed state. In the absence of a collision event, the inflatable cushion 120 may be rolled, folded, or otherwise compressed to fit within the housing 110. The inflatable cushion 120 may be formed from a cut and sewn cushion, a one-piece woven (OPW) or tubular webbing, or any suitable material. The inflator assembly 105 may be triggered to inflate the inflatable cushion 120 by one or more suitable sensors or devices within the vehicle. In some embodiments, the inflator assembly 105 may be triggered to inflate the inflatable cushion 120 when a frontal airbag is triggered to inflate.

FIG. 1B provides a front view of the airbag assembly 100 in the deployed configuration. As shown, the airbag assembly 100 can include the first and second lateral chambers 120a, 120b. The first and second lateral chambers 120a, 120b may be disposed opposite of each other relative to the seat 52. Specifically, the first lateral chamber 120a may be disposed at or adjacent a first side of the occupant 54, and the second lateral chamber 120b may be disposed at or adjacent a second side of the occupant 54.

FIGS. 1A and 1B illustrate the airbag assembly 100 in a deployed state with the inflatable cushion 120 inflated with an inflation gas. When in a deployed configuration, the first and second lateral chambers 120a, 120b of the inflatable cushion 120 can each have a curved profile such that they are configured to be disposed around at least a portion of a torso of the occupant 54 in the vehicle seating position 10 (e.g., a position in which the occupant 54 is generally positioned when seated in the seat 52 of the vehicle). In various embodiments, the curved profile of the first and second lateral chambers 120a, 120b (e.g., the disposition of the deployed lateral chambers 120a, 120b around the torso of the occupant 54) may be formed by one or more of: angling the housing 110 at or adjacent the rear of the seat 52; shaping the material forming the first and second lateral chambers 120a, 120b; using internal tethers (i.e., disposed within at least a portion of a void 109 of the first and second lateral chambers 120a, 120b); using sewn “pleats” (e.g., gathered material) in the first and second lateral chambers 120a, 120b to form a shorter length on the lower surface as compared to the upper surface; or a combination thereof.

The first lateral chamber 120a may comprise a proximal portion 114a, a middle portion 116a, and a distal portion 118a. Likewise, the second lateral chamber 120b may comprise a proximal portion 114b, a middle portion 116b, and a distal portion 118b. The proximal portions 114a, 114b can be coupled to the housing 110 at a first end, and coupled to the middle portions 116a, 116b, respectively, at a second end. Furthermore, the middle portions 116a, 116b can be coupled to the proximal portions 114a, 114b, respectively, at a first end and to the distal portions 118a, 118b, respectively, at a second end. In certain embodiments, when the first lateral chamber 120a is inflated, the middle portion 116a can be disposed over a first shoulder and adjacent a first side of a head 56 of the occupant 54. The distal portion 118a can be coupled to the middle portion 116a at a first end and can be closed or sealed at a second end (i.e., a distal end). When the first lateral chamber 120a is inflated, the distal portion 118a can be disposed along at least a portion of a front of the torso of the occupant 54. For example, the distal portion 118a may extend from a position adjacent a shoulder of the occupant 54 to a position adjacent a lap of the occupant 54.

As shown in FIG. 1B, when the second lateral chamber 120b is inflated, the middle portion 116b can be disposed over a second shoulder and adjacent a second side of the head 56 of the occupant 54. The distal portion 118b can be coupled to the middle portion 116b at a first end and can be closed or sealed at a second end (i.e., a distal end). When the second lateral chamber 120b is inflated, the distal portion 118b can be disposed along at least a portion of a front of the torso of the occupant 54. For example, the distal portion 118b may extend from a position adjacent a shoulder of the occupant 54 to a position adjacent a lap of the occupant 54.

The proximal portions 114a, 114b of the first and second lateral chambers 120a, 120b of the inflatable cushion 120 may be coupled to the housing 110 (e.g., to the first and second inflators 105a, 105b, respectively) such that the proximal portions 114a, 114b are configured to receive the inflation gas from the inflator assembly 105. The portions of the first and second lateral chambers 120a, 120b (i.e., the proximal portions 114a, 114b, the middle portions 116a, 116b, and the distal portions 118a, 118b) may be in fluid communication with each other such that the proximal portions 114a, 114b are configured to allow or direct the inflation gas to flow through to the middle portions 116a, 116b, and the middle portions 116a, 116b are configured to allow or direct the inflation gas to flow through to the distal portions 118a, 118b, respectively.

During a collision event, the proximal portions 114a, 114b may inflate and the pressure from the inflation gas may cause the first and second lateral chambers 120a, 120b to exit the first and second lateral housing portions 110a, 110b, respectively. Furthermore, the middle and distal portions 116a, 116b, 118a, 118b can also be configured to inflate. The airbag assembly 100 is configured such that the first and second lateral chambers 120a, 120b exit the top portions of the first and second lateral housing portions 110a, 110b respectively. In various embodiments, the airbag assembly 100 may be configured such that the first and second lateral chambers 120a, 120b exit the first and second lateral housing portions 110a, 110b from other suitable portions of the first and second lateral housing portions 110a, 110b respectively—for example, a rear of the first and second lateral housing portions 110a, 110b, respectively.

With continued reference to FIG. 1B, the first and second lateral chambers 120a, 120b may be configured such that the distal portions 118a, 118b of the first and second lateral chambers 120a, 120b, respectively, are substantially parallel with each other. For example, the first end of the distal portion 118a of the first lateral chamber 120a may have a distance from the first end of the distal portion 118b of the second lateral chamber 120b that is substantially equal to the distance from the second end (i.e., the distal end) of the distal portion 118a of the first lateral chamber 120a to the second end (i.e., the distal end) of the distal portion 118b of the second lateral chamber 120b. In some embodiments, the first and second lateral chambers 120a, 120b may be configured such that the distal portions 118a, 118b of the first and second lateral chambers 120a, 120b, respectively, are not substantially parallel with each other. For example, the first end of the distal portion 118a of the first lateral chamber 120a may have a distance from the first end of the distal portion 118b of the second lateral chamber 120b that is substantially larger to the distance from the second end (i.e., the distal end) of the distal portion 118a of the first lateral chamber 120a to the second end (i.e., the distal end) of the distal portion 118b of the second lateral chamber 120b.

In either a frontal or oblique impact event, the airbag assembly 100 may be configured such that the first and second lateral chambers 120a, 120b may receive a portion of the force of the occupant 54 while the seatbelt 60 may receive another portion of the force of the occupant 54. The first and second lateral chambers 120a, 120b may lessen the force of the seatbelt 60 on the occupant 54. Further, whether the first and second lateral chambers 120a, 120b are in a packaged state or in a deployed state, the airbag assembly 100 may function independent of the seatbelt 60. The first and second lateral chambers 120a, 120b may be configured to exert a force on the occupant 54 in a vehicle collision event such that, with or without the seatbelt 60 being fastened around the occupant 54, the movement of the occupant 54 may be substantially restricted.

In certain embodiments, the first and second lateral chambers 120a, 120b can restrain an occupant 54 moving in a forward, lateral, and/or oblique direction from the vehicle seating position 10 relative to the vehicle. Pressure inside the first and second lateral chambers 120a, 120b (e.g., due to the inflation gas within the void 109) can apply a downward and/or a rearward force on the shoulders and/or the torso of the occupant 54. In some embodiments, interaction (e.g., pressure and friction) between a frontal airbag 106 and the first and second lateral chambers 120a, 120b can also apply a rearward force on the occupant 54.

In certain embodiments, during an oblique vehicle impact event, the occupant 54 may move in both a forward direction and a lateral direction relative to the vehicle (e.g., from the vehicle seating position 10). For example, if an impact occurs on a right lateral side of the vehicle, the occupant 54 may move forward and to the right from the vehicle seating position 10. Accordingly, the inflatable cushion 120 may be configured such that the first lateral chamber 120a receives at least a portion of the neck, the head, and/or the shoulder of the occupant 54.

Referring to FIG. 1A, in some embodiments, the tether 170 may comprise a first end 171 and a second end 172. The first end 171 may be coupled to the tension control mechanism 180. The second end 172 may be attached to the inflatable cushion 120 using in suitable technique, such as sewing, gluing, fasteners, etc. As shown in FIG. 1A, the tether 170 may be disposed within the back of the seat 52. The tether 170 may be configured as any suitable elongated member, such as a strap, rope, cable, line, cord, string, wire, chain, web, band, etc. The tether 170 may comprise a woven material, such as a woven nylon material. Other materials, such as woven polyester, woven polypropylene, natural or other synthetic fibers in the form of webbing, fabric, rope, etc., with suitable tensile and elongation properties to withstand loads (or forces) that may be applied to the tether 170 during deployment of the airbag assembly 100 may be utilized and are contemplated within the scope of the disclosure.

As illustrated in FIG. 1A, the tension control mechanism 180 may be disposed within the back of the seat 52 at a lower level than the housing 110. The tether 170 may initially extend substantially vertically from the tension control mechanism 180 to the housing 110 within the back of the seat 52. The back of the seat 52 may comprise a tear seam 55 in alignment with the tether 170.

In certain embodiments, the tension control mechanism 180 may comprise a pretensioning retractor 181 and a load limiting member 182. In some embodiments, the pretensioning retractor 181 comprises the load limiting member 182. In other embodiments, the pretensioning retractor 181 and the load limiting member 182 may be configured as an integral unit. In some embodiments, the pretensioning retractor 181 and the load limiting member 182 are separate components of the tension control mechanism. In certain embodiments, the tether 170 may be sequentially coupled to the pretensioning retractor 181 and then to the load limiting member 182. In other embodiments, the tether 170 may be sequentially coupled to the load limiting member 182 and then to the pretensioning retractor 181. In still other embodiments, the tether 170 may be coupled to the pretensioning retractor 181 and the load limiting member 182 in parallel.

The tension control mechanism 180 may be configured to control a level of tension applied to the tether 170 during different states of deployment of the inflatable cushion 120. The pretensioning retractor 181 may be configured to apply pretension or rearwardly directed tension or force to the inflatable cushion 120 following full deployment or near full deployment of the inflatable cushion 120. The pretensioning of the tether 170 may rapidly shorten a length of the tether 170 and reduce a gap distance between the occupant 54 and the deployed inflatable cushion 120, so that the occupant 54 may be better restrained in the vehicle seating position 10 following an impact as will be discussed in additional detail below.

The pretensioning retractor 181 may be configured as any suitable mechanism known in the art to rapidly apply a tension force and retract the tether 170 into the tension control mechanism 180, such as a linear piston retractor, a rotational retractor, a linear rack and pinion retractor, etc. In some embodiments, the pretensioning retractor 181 may be activated following full deployment or near full deployment of the inflatable cushion 120.

The load limiting member 182 of the tension control mechanism 180 may be configured to permit controlled forward extension of the tether 170 from the tension control mechanism 180 following impact of the inflatable cushion 120 by the occupant 54 and during the ride down state of the airbag assembly 100. The load limiting member 182 may be a factor in the kinematics of the ride down state by controlling forward extension of the tether 170. The load limiting member may be configured to apply a load or drag force to the tether 170 to control forward extension. The rate of forward extension of the tether 170 may be controlled through a response to a forwardly directed tension force applied to the tether 170. The load limiting member 182 may apply a constant or variable load or drag force to the tether 120. Controlled forward extension of the tether 170 may permit the inflatable cushion 120 to be displaced forwardly such that impact energy of the occupant 54 is partially absorbed by the force controlled forward displacement of the inflatable cushion 120. For example, following initial high speed impact of the inflatable cushion 120 by the occupant 54 and high forward directed tension force, the inflatable cushion 120 may be allowed to move forward when the load limiting member 182 controllably allows forward extension of the tether 170 at a rate dependent upon the forward directed tension force, e.g. a higher drag force under a higher tension force and a lower drag force under a lower tension force. A resultant of the controlled extension may be a controlled deceleration of the rate of forward movement of the occupant 54, leading to a reduction in risk of trauma to the occupant from the inflatable cushion 120. A second factor of the kinematics of the ride down state is controlled deflation of the inflatable cushion 120 through the material or vents of the inflatable cushion 120. The function of the load limiting member 182 and venting of the inflatable cushion 120 may be configured to work in parallel to optimize the kinematics of the ride down state of the airbag assembly 100.

Examples of load limiting functions of exemplary load limiting members are disclosed in U.S. Pat. No. 9,327,681, which is incorporated by reference. In certain embodiments, the load limiting member 182 may control the rate of forward movement of the tether 170 and the inflatable cushion 120 in response to a threshold tension force or load applied to the tether 170. For example, the load limiting member 182 may allow the tether 170 to be displaced forwardly when a forwardly directed threshold tension force or load applied to the tether 170 is exceeded and to stop the forward displacement when the tension force or load is less than the threshold force or load.

In some embodiments, the load limiting member 182 may be configured as a digressive functioning component such that the load or drag force starts at a higher load and then drops to a lower load. The load limiting member 182 may comprise a spring which is bent around a spindle as the tether 170 is extended. The spring may be configured to bend differentially dependent upon the load applied to the spindle.

In other embodiments, the load limiting member 182 may be configured as a progressive functioning component. For example, extension of the tether 170 is controlled by an initial medium load or drag force and then progresses to a high load or drag force.

In other embodiments, the load limiting member 182 may be configured as an adaptive function such that timing of a switch from the high load or drag force to a lower load or drag force is controlled. For example, the load limiting member 182 may comprise two torsion bars, a high load torsion bar and a low load torsion bar. Switching from the high load torsion bar to the low load torsion bar may occur through pyrotechnic actuation at a preset load or tether extension distance.

In other embodiments, a tear stitch in the tether 170 could be utilized as a load limiting member. The tear stitch may be designed to burst at a threshold level of loading of the inflatable cushion. In still other embodiments, the tether 170 may include perforations and/or other forms of material release that can operate as a load limiting member, or otherwise to provide load limiting functionality.

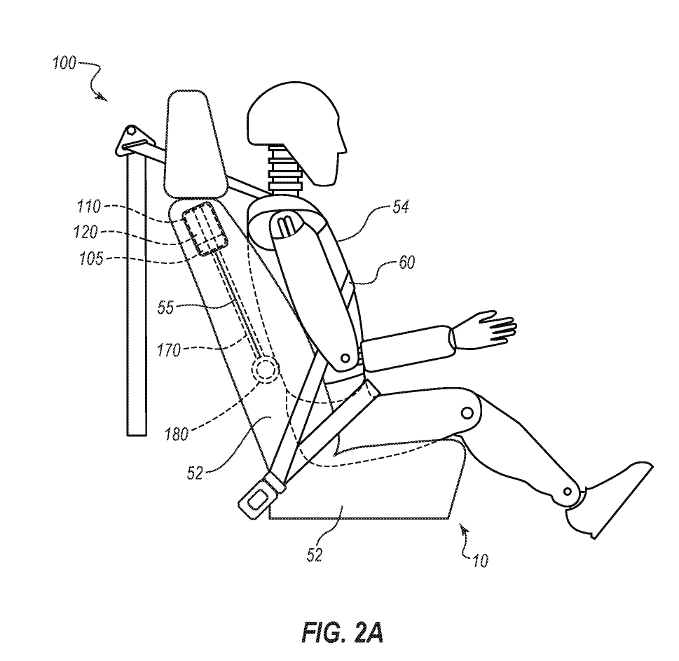

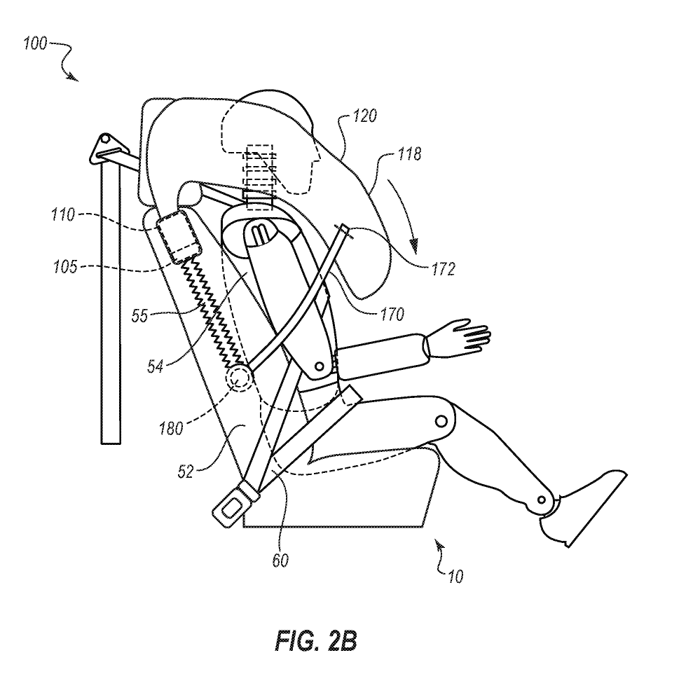

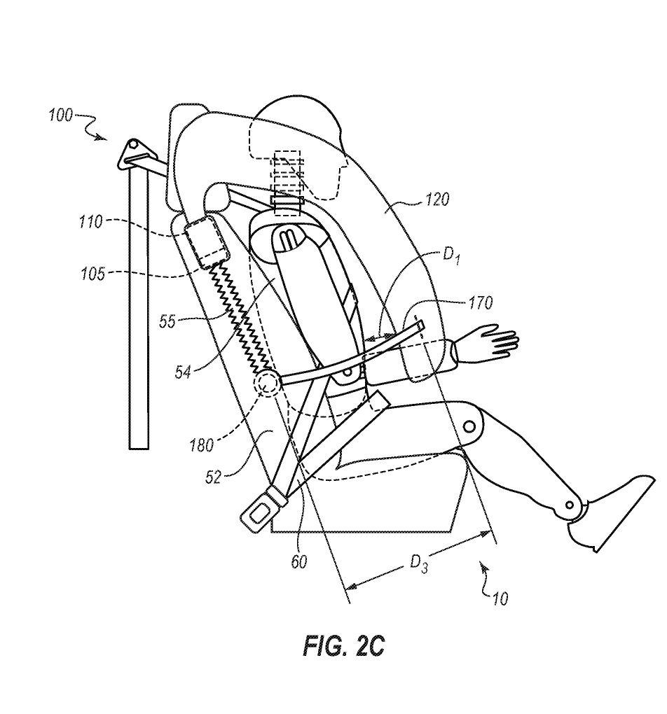

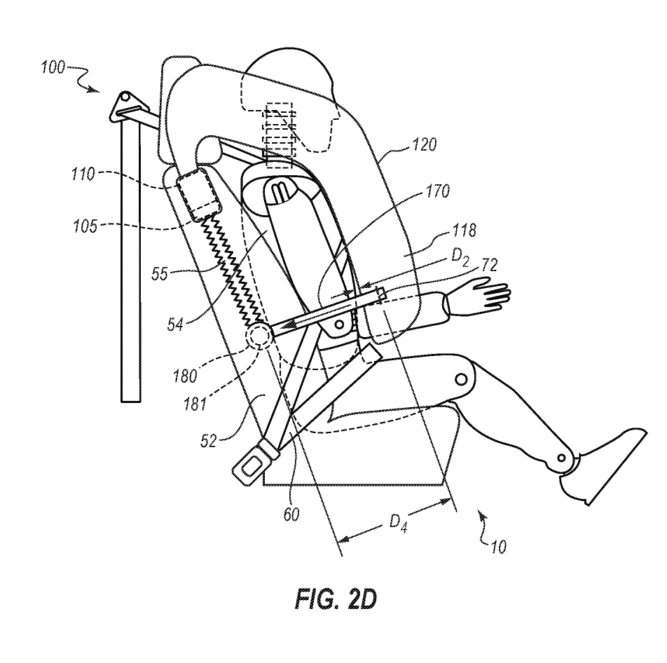

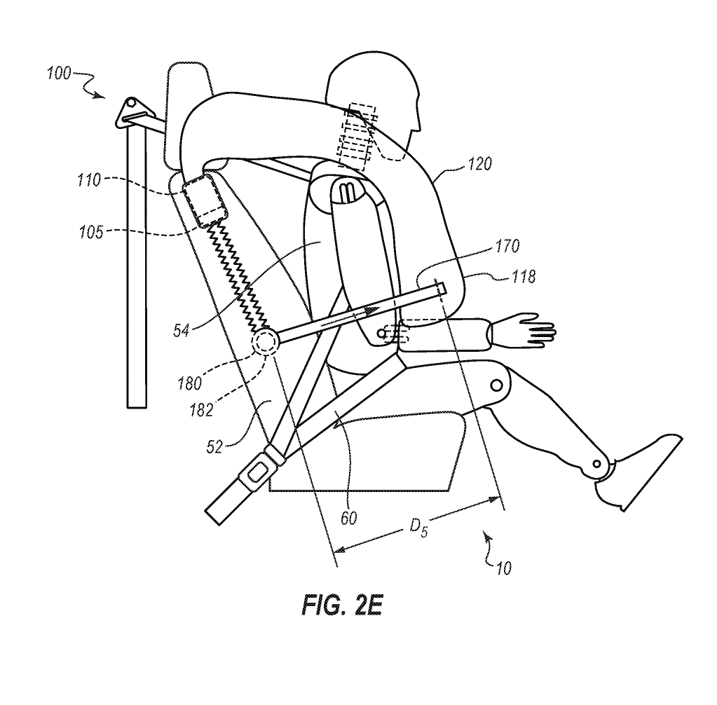

FIGS. 2A-2E illustrate the airbag assembly 100 in various configurations or states during deployment of the airbag assembly 100. FIG. 2A illustrates the airbag assembly 100 in a ready configuration prior to deployment. FIG. 2B illustrates the airbag assembly 100 in a partially deployed configuration. FIG. 2C illustrates the airbag assembly 100 in a deployed or deploying configuration prior to pretensioning of the tether 170. In other words, the tether 170 may be pretensioned during deployment of the airbag assembly 100 or following full deployment of the airbag assembly 100. FIG. 2D illustrates the airbag assembly 100 in a deployed configuration following pretensioning of the tether 170. FIG. 2E illustrates the airbag assembly 100 in a deployed configuration during ride down of the inflatable cushion 120.

Referring to FIG. 2A, the occupant 54 is shown disposed on or in the seat 52 in the vehicle seating position 10. A seatbelt 60 is disposed around the occupant 54. The housing 110 of the airbag assembly 100 is disposed within the seat 52 adjacent the top of the seat back. The inflatable cushion 120 and inflator assembly 105 are disposed within the housing 110. The tension control mechanism 180 is disposed within the seat 52 adjacent to or toward a lower portion of the seat back. The tether 170 is disposed within the seat 52 extending from the inflatable cushion 120 to the tension control mechanism 180. The tether 170 may be aligned with the tear seam 55, as shown.

As illustrated in FIG. 2B, the airbag assembly 100 is in a partially deployed configuration. The inflatable cushion 120 is partially filled with gas from the inflator assembly 105 and is extending from the housing 110. The inflatable cushion 120 is directed upward and forward over a shoulder of the occupant 54. The tear seam 55 is opened by the tether 170 as the tether 170 is deployed with the inflatable cushion 120. The second end 172 of the tether 170 is coupled to the distal portion 118 of the inflatable cushion 120. The second end 172 may be deployed with the inflatable cushion 120 in an arc shaped movement. The tether 170 is configured with slack length such that initially there is not a tension force applied to the tether 170 as the inflatable cushion 120 inflates. The tether 170 and inflatable cushion 120 may be configured to avoid contacting the occupant 54 during initial deployment (e.g., during inflation of the inflatable cushion 120).

FIG. 2C shows the inflatable cushion 120 in a fully or a nearly fully deployed configuration. The inflatable cushion 120 is filled with gas from the inflator assembly 105 and disposed forward of the occupant 54. A gap between the torso of the occupant 54 and the rearward facing surface of the inflatable cushion 120 has a distance D₁. The tether 170 is deployed and is configured with a slack length of distance D₃ such that the distal portion 118 of the inflatable cushion 120 is unrestrained.

As illustrated in FIG. 2D, the torso of the occupant 54 engages the inflatable cushion 120 of the airbag assembly 100 during the collision event. The engagement occurs due to two opposing movements. One movement is an initial movement of the occupant 54 forward from the vehicle seating position 10. For example, at, during, or following the collision event, the occupant 54 may be displaced forwardly or obliquely within the vehicle. The second movement is a rearward movement of the inflatable cushion 120 toward the occupant 54. This occurs when the pretension retractor 181 of the tension control mechanism 180 is activated. The activated pretension retractor 181 applies a pretension force to the tether 170. The resultant action is retraction of the tether 170 into the pretension retractor 181 such that the second end 172 of the tether 170 is displaced rearwardly, as shown by the arrow on the tether 170. The retraction of the tether 170 eliminates the slack in the tether 170 and shortens the effective length of the tether 170 resulting in an effective tether length of distance D₄. Additionally, the inflatable cushion 120 is displaced rearwardly by retracting the tether 170 such that the gap between the torso of the occupant 54 and the rearward facing surface of the inflatable cushion 120 has a distance D₂ which may be zero, or at least is smaller than distance D₁. If the effective tether length remained long (e.g., at distance D₄), the tether 170 would not provide the desired force to limit forward displacement of the inflatable cushion 120 and the occupant 54. This retracting or pretensioning of the tether 170 that occurs at occupant loading may be prior to occupant loading and/or during occupant loading of the inflatable cushion 120.

Referring now to FIG. 2E, the occupant 54 is shown to continue forward movement while being restrained by the airbag assembly 100. The seatbelt 60, if used, may also aid to restrain forward movement of the occupant 54. The airbag assembly 100 is shown in a ride down state. The ride down state is intended to absorb a portion of the impact force of the occupant 54 onto the inflatable cushion 120 such that physical injury to the occupant 54 may be reduced. The ride down state may comprise two functional elements. First, the gas within the inflatable cushion 120 may be vented from inflatable cushion 120 in a controlled manner such that the occupant 54 may continue a controlled forward movement. The venting of gas may be through the material of the inflatable cushion 120 and/or through vents (not shown) through panels of the inflatable cushion 120. The second element is that the pretension force or load applied to the tether 170, as describe previously, may be reduced by the load limiting member 182 of the tension control mechanism 180 such that the tether 170 and distal portion 118 of the inflatable cushion 120 are displaced forwardly by the force or load of the forward movement of the occupant 54. The length of the tether 170 following the ride down state is distance D₅. The distance D₅ may be longer than the distance D₄ of FIG. 2D.

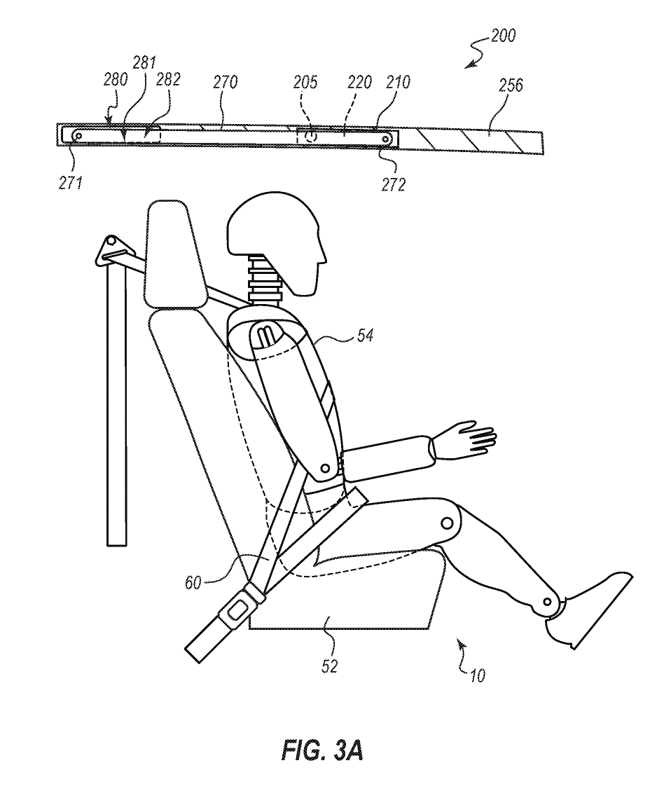

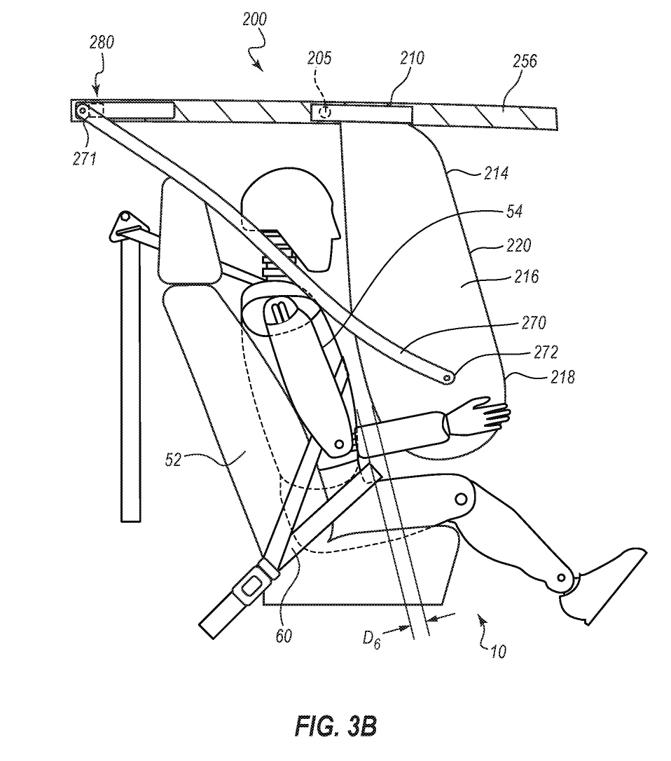

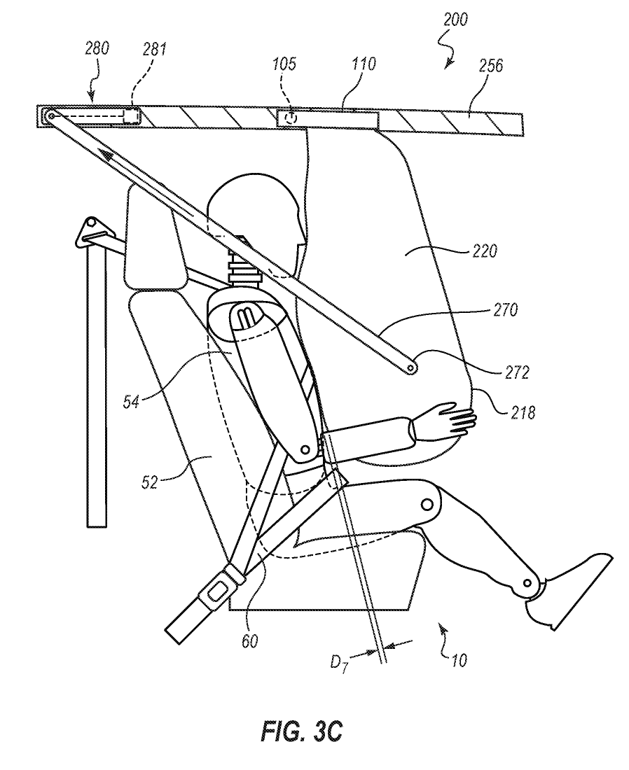

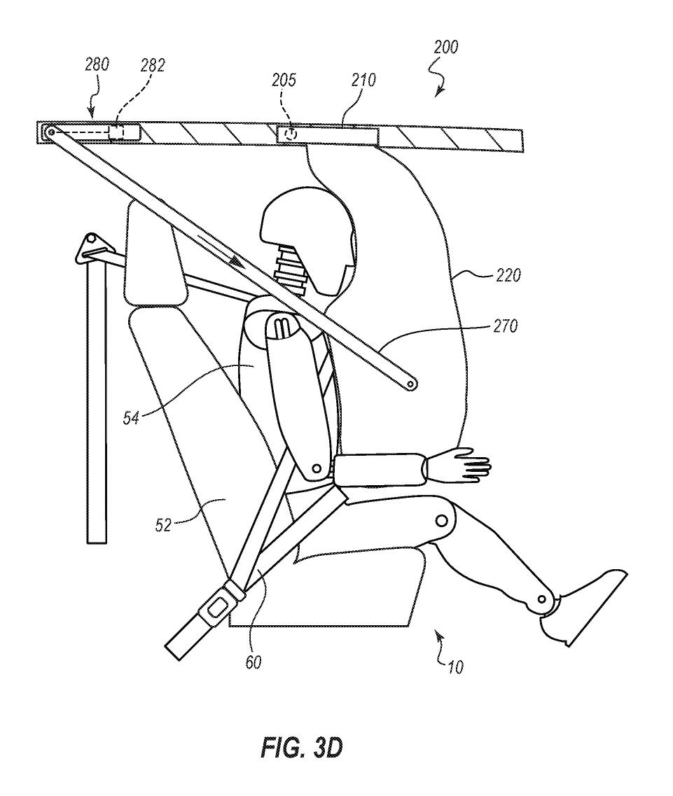

FIGS. 3A-3D depict an embodiment of an airbag assembly 200 that resembles the airbag assembly 100 described above in certain respects. Accordingly, like features are designated with like reference numerals, with the leading digits incremented to “2.” For example, the embodiment depicted in FIGS. 3A-3D include a tension control mechanism 280 that may, in some respects, resemble the tension control mechanism 180 of FIGS. 1A-1B. Relevant disclosures set forth above regarding similarly identified features thus may not be repeated hereafter. Moreover, specific features of the airbag assembly 100 and related components shown in FIGS. 1A-1B and 2A-2E may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the airbag assembly and related components depicted in FIGS. 3A-3D. Any suitable combination of the features, and variations of the same, described with respect to the airbag assembly 100 and related components illustrated in FIGS. 1A-1B and 2A-2E can be employed with the airbag assembly 200 and related components of FIGS. 3A-3D, and vice versa. This pattern of disclosure applies equally to further embodiments depicted in subsequent figures and described hereafter, wherein the leading digits may be further incremented.

FIGS. 3A-3D illustrate an airbag assembly 200 in various configurations or states of deployment of the airbag assembly 200. FIG. 3A illustrates the airbag assembly 200 in a packaged configuration prior to deployment. FIG. 3B illustrates the airbag assembly 200 in a deployed or deploying configuration prior to pretensioning of a tether 270. FIG. 3C illustrates the airbag assembly 200 in a deployed configuration following pretensioning of the tether 270. FIG. 3D illustrates the airbag assembly 200 in a deployed configuration during ride down of an inflatable cushion 220.

FIG. 3A depicts the airbag assembly 200 in a packaged state. The airbag assembly 200 may comprise a housing 210, an inflator assembly 205, an inflatable cushion 220, the tether 270, and a tension control mechanism 280. The housing 210 may be disposed in a headliner 256 of a vehicle above and forward of the occupant 54 in the vehicle seating position 10. The housing 210 may be coupled to the headliner 256 and/or roof of the vehicle using any suitable technique, such as fasteners, adhesive, straps, welding, etc. The housing 210 may house the inflatable cushion 220 and the inflator assembly 205. A portion of the housing 210 may be configured to open in response to a force applied by the inflatable cushion 220 as the inflatable cushion 220 is inflated. The inflator assembly 205 may be configured to deliver a gas to the inflatable cushion 220. The inflatable cushion 220 may be rolled or folded and disposed within the housing 210 prior to inflation.

The inflatable cushion 220 may comprise a single chamber or lobe as shown in FIG. 3B. The inflatable cushion 220 may be configured to be disposed forward of the occupant 54 when deployed and filled with gas from the inflator assembly 205. The inflatable cushion 220 may comprise a proximal portion 214, a middle portion 216, and a distal portion 218.

With continued reference to FIG. 3A, the tension control mechanism 280 may be disposed in the headliner 256. In some embodiments the tension control mechanism 280 may be disposed rearward of the housing 210. In other embodiments, the tension control mechanism 280 may be disposed forward of the housing 210. The tension control mechanism 280 may be attached to the headliner 256 and/or roof of the vehicle using any suitable technique, such as fasteners, adhesive, straps, welding, etc. The tension control mechanism 280 may comprise a pretensioning retractor 281 and a load limiting member 282, potentially similar to that as described previously relative to the tension control mechanism 180 of the airbag assembly 100.

The tether 270 may be disposed within the headliner 256. A first end 271 of the tether 270 may be coupled to the tension control mechanism 280. A second end 272 of the tether 270 may be attached to the inflatable cushion 220. The second end 272 may be attached to the inflatable cushion 220 using any suitable technique, such as sewn, adhesive, fasteners, heat welding, etc. In other embodiments, the tether 270 may be an extension of the inflatable cushion 220 such that the tether 270 is integral with the inflatable cushion 220

FIG. 3B illustrates the airbag assembly 200 in a deployed configuration or state. The inflatable cushion 220 is shown to be inflated. The inflated inflatable cushion 220 extends downward from the housing 210 and is disposed forward of the occupant 54 in the vehicle seating position 10. The tether 270 extends from the distal portion 218 of the inflatable cushion 220 diagonally upwardly and rearwardly to the tension control mechanism 280. A length of the tether 270 is configured with slack such that the tether 270 does not apply any force (e.g., upwardly and/or rearwardly) to the inflatable cushion 220. A gap between the torso of the occupant 54 and a rearwardly facing surface of the inflatable cushion 220 has a distance D₆.

FIG. 3C illustrates the airbag assembly 200 in a fully or nearly fully deployed configuration or state. The inflatable cushion 220 is shown to be inflated. The tether 270 is partially retracted into the pretensioning retractor 281 as shown by the arrow such that the slack is removed and a pretension load or force is applied to the tether 270. The distal portion 218 of the inflatable cushion 220 is displaced upwardly and rearwardly by the retracting tether 270 such that the gap between the torso of the occupant 54 and the rearward facing surface of the inflatable cushion 220 has a distance of D₇ which may be substantially zero or may be less than D₆. The pretensioning of the tether 270 to displace the inflatable cushion 220 rearwardly and upwardly is configured to secure the occupant 54 in the vehicle seating position 10 following a collision event. In certain embodiments, a seatbelt 60 is used in conjunction with the airbag assembly 200.

FIG. 3D depicts the airbag assembly 200 in a ride down state. The occupant 54 is displaced forwardly of the vehicle seating position 10. The occupant 54 may apply a forward force or load to the inflatable cushion 220. The inflatable cushion 220 may be deflating wherein the inflation gas may egress through the material of the inflatable cushion 220 and/or through vents (not shown) coupled to the inflatable cushion 220. The load limiting member 282 can allow the tether 270 and distal end 218 of the inflatable cushion 220 to move forwardly and downwardly at a controlled rate as shown by the arrow.

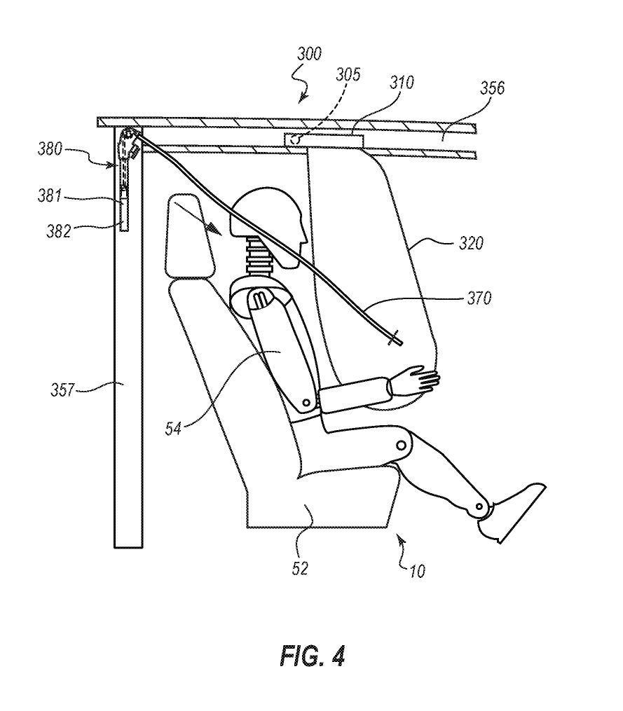

FIG. 4 shows an airbag assembly 300, according to another embodiment of the present disclosure. The airbag assembly 300 may be similar to the airbag assembly 200 of FIGS. 3A-3D. As depicted in FIG. 4, the airbag assembly 300 comprises a housing 310 and an inflator assembly 305 disposed within a headliner 356 forward of an occupant 54 in the vehicle seating position 10. The housing 310 may be coupled or attached to a roof of a vehicle or other suitable vehicle structure. The airbag assembly 300 further comprises an inflatable cushion 320 configured to be filled with gas from the inflator assembly 305. The inflatable cushion 320 is deployed from the housing 310 to a position forward of the occupant 54 and/or the vehicle seating position 10. The airbag assembly 300 further comprises a tension control mechanism 380 which comprises a pretensioning retractor 381 and a load limiting member 382. As shown in FIG. 4, the tension control mechanism 380 is coupled to a structure of the vehicle. For example, the tension control mechanism 380 may be attached to a door column or B-pillar 357. In other embodiments, the tension control mechanism 380 may be attached to any suitable structure in the vehicle, such as the A-pillar, C-pillar, etc. A tether 370 is coupled or attached to the tension control mechanism 380 at one end and the inflatable cushion 320 at an opposite end. The tether 370 diagonally upwardly and rearwardly from the inflatable cushiong 320 to the tension control mechanism 380.

In use, at, during, or following a collision event, the airbag assembly 300 may be activated. The inflatable cushion 320 may be filled with gas from the inflator assembly 305 such that the inflatable cushion 320 may be deployed from the housing 310 to a position forward of the occupant 54. Following or during deployment, the pretensioning retractor 381 may apply a pretensioning or retractive load or force to the tether 370 such that the tether 370 may be at least partially retracted into the pretensioning retractor 381 and displaced upwardly and rearwardly. The displacement of the tether 370 may displace the inflatable cushion 320 upwardly and rearwardly such that a gap between the occupant 54 and a rearwardly facing surface of the inflatable cushion 320 is closed such that the inflatable cushion 320 makes contact with the torso of the occupant 54.

Following pretensioning of the tether 370 and contact of the occupant 54 with the inflatable cushion 320, the airbag assembly 300 may transition to a ride down state. During the ride down state, the inflatable cushion 320 may be controllably deflated by venting of the gas from the inflatable cushion 320. Additionally, the load limiting member 382 may control the rate of displacement of the tether 370 forwardly and downwardly from the tension control mechanism 380.

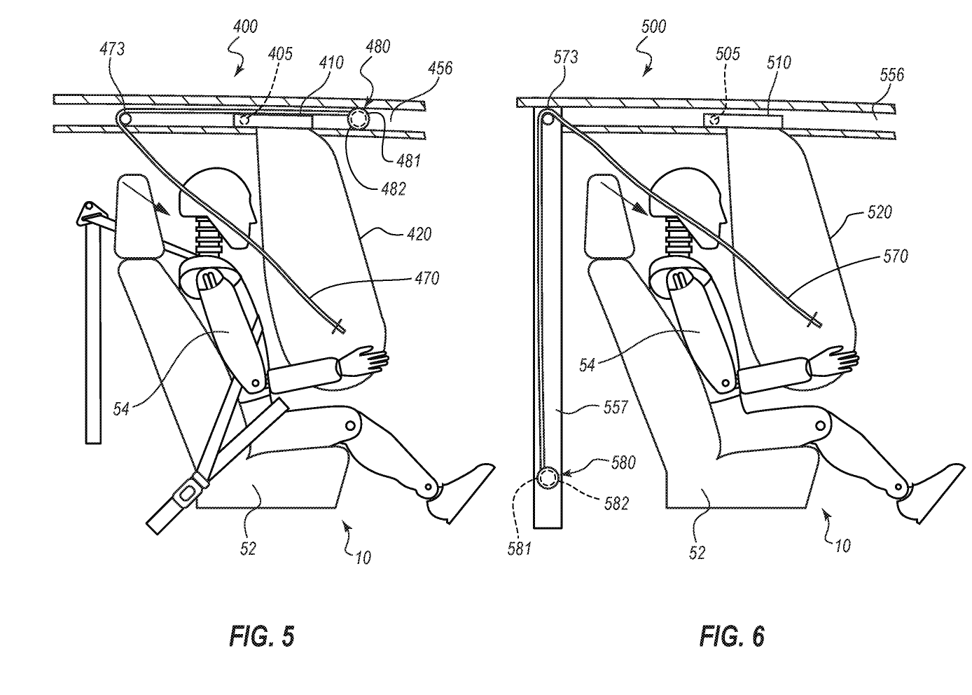

FIG. 5 shows an airbag assembly 400, according to another embodiment. The airbag assembly 400 may be similar to the airbag assembly 200 of FIGS. 3A-3D. As depicted in FIG. 5, the airbag assembly 400 comprises a housing 410 and an inflator assembly 405 disposed within a headliner 456 forward of the occupant 54 in the vehicle seating position 10. The housing 410 may be coupled to a roof of a vehicle or any other suitable vehicle structure. The airbag assembly 400 further comprises an inflatable cushion 420 configured to be filled with gas from the inflator assembly 405. The inflatable cushion 420 can be deployed from the housing 410 to a position forward of the occupant 54. The airbag assembly 400 further comprises a tension control mechanism 480 which comprises a pretensioning retractor 481 and a load limiting member 482. As shown in FIG. 5, the tension control mechanism 480 is coupled to a structure of the vehicle. For example, the tension control mechanism 480 may be disposed forward of the housing 410 and be coupled to a roof of a vehicle. A tether 470 is coupled to the tension control mechanism 480 at one end and the inflatable cushion 420 at an opposite end. A portion of the tether 470 may pass over or through a loop member 473 such that the tether 470 is directed diagonally downward and forward from the loop member 473 to the deployed inflatable cushion 420 and horizontally forward from the loop member 473 to the tension control mechanism 480.

In use, at, during, or following a collision event, the airbag assembly 400 may be activated. The inflatable cushion 420 may be filled with gas from the inflator assembly 405 such that the inflatable cushion 420 may be deployed from the housing 410 to a position forward of the occupant 54. Following or during deployment, the pretensioning retractor 481 may apply a pretensioning or retractive load or force to the tether 470 such that the tether 470 may be at least partially retracted into the pretensioning retractor 481 and displaced upwardly and rearwardly toward the loop member 473 and horizontally forward to the tension control mechanism 480. The displacement of the tether 470 may displace the inflatable cushion upwardly and rearwardly such that a gap between the occupant 54 and a rearwardly facing surface of the inflatable cushion 420 is closed such that the inflatable cushion 420 makes contact with the torso of the occupant 54.

Following pretensioning of the tether 470 and contact of the occupant 54 with the inflatable cushion 420, the airbag assembly 400 may transition to a ride down state. During the ride down state, the inflatable cushion 420 may be controllably deflated by venting of the gas from the inflatable cushion 420. Additionally, the load limiting member 482 may control the rate of displacement of the tether 470 horizontally rearward from the tension control mechanism 480 and diagonally forward and downward from the loop member 473.

FIG. 6 shows an airbag assembly 500, according to another embodiment. The airbag assembly 500 may be similar to the airbag assembly 200 of FIGS. 3A-3D. As depicted in FIG. 5, the airbag assembly 500 comprises a housing 510 and an inflator assembly 505 disposed within a headliner 556 forward of the occupant 54 in the vehicle seating position 10. The housing 510 may be coupled to a roof of a vehicle. The airbag assembly 500 further comprises an inflatable cushion 520 configured to be filled with gas from the inflator assembly 505. The inflatable cushion 520 may be deployed from the housing 510 to a position forward of the occupant 54. The airbag assembly 500 further comprises a tension control mechanism 580 which comprises a pretensioning retractor 581 and a load limiting member 582. As shown in FIG. 6, the tension control mechanism 580 is coupled to a structure of the vehicle. For example, the tension control mechanism 580 may be coupled to a lower portion of a door column or B-pillar 557. A tether 570 is coupled to the tension control mechanism 580 at one end and the inflatable cushion 520 at an opposite end. A portion of the tether 570 may pass over or through a loop member 573 such that the tether 570 is directed diagonally downward and forward from the loop member 573 to the deployed inflatable cushion 520 and vertically downward from the loop member 573 to the tension control mechanism 580.

In use, at, during, or following a collision event, the airbag assembly 500 may be activated. The inflatable cushion 520 may be filled with gas from the inflator assembly 505 such that the inflatable cushion 520 may be deployed from the housing 510 to a position forward of the occupant 54. Following or during deployment, the pretensioning retractor 581 may apply a pretensioning or retractive load or force to the tether 570 such that the tether 570 may be at least partially retracted into the pretensioning retractor 581 and displaced upwardly and rearwardly toward the loop member 573 and vertically downward to the tension control mechanism 580. The displacement of the tether 570 may displace the inflatable cushion 520 upwardly and rearwardly such that a gap between the occupant 54 and a rearwardly facing surface of the inflatable cushion 520.

Following pretensioning of the tether 570 and contact of the occupant 54 with the inflatable cushion 520, the airbag assembly 500 may transition to a ride down state. During the ride down state, the inflatable cushion 520 may be controllably deflated by venting of the gas from the inflatable cushion 520. Additionally, the load limiting member 582 may control the rate of displacement of the tether 570 horizontally rearward from the tension control mechanism 580 and diagonally forward and downward from the loop member 573.

Without further elaboration, it is believed that one skilled in the art may use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art, and having the benefit of this disclosure, that changes may be made to the details of the above-described embodiments without departing from the underlying principles of the disclosure herein.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 ¶6. It will be apparent to those having reasonable skill in the art that changes may be made to the details of the above-described embodiments without departing from the underlying principles of the invention. Embodiments of the invention in which an exclusive property or privilege is claimed are defined as follows.

1. A vehicle occupant protection system, comprising:
an inflatable airbag cushion to receive inflation gas from an inflator assembly to deploy the inflatable airbag cushion forward of a vehicle seating position;
a tension element comprising a first end secured to the inflatable airbag cushion and a second end; and
a pretensioning mechanism secured to the second end of the tension element, wherein the pretensioning mechanism is configured to be secured to a vehicle structure and to apply a tension force to the tension element at occupant loading of the inflatable airbag cushion.

2. The vehicle occupant protection system of claim 1, wherein the vehicle structure is one of an occupant seat, a roof structure, and a pillar.

3. The vehicle occupant protection system of claim 1, wherein the pretensioning mechanism applies the tension force to the tension element when the inflatable airbag cushion has been at least partially deployed.

4. The vehicle occupant protection system of claim 1, wherein the pretensioning mechanism is configured to apply a rearward force to the tension element.

5. The vehicle occupant protection system of claim 4, wherein the rearward force applied to the tension element is configured to apply a rearward force to a portion of the inflatable airbag cushion.

6. The vehicle occupant protection system of claim 4, wherein the rearward force applied to the tension element is configured to retain an occupant in a vehicle seating position by the inflatable airbag cushion.

7. The vehicle occupant protection system of claim 1, wherein the pretensioning mechanism applies the tension force to the tension element following deployment of the inflatable airbag cushion forward of the occupant.

8. The vehicle occupant protection system of claim 1, wherein the tension force is configured to reduce space between the deployed inflatable airbag cushion and an occupant seated in the vehicle seating position.

9. The vehicle occupant protection system of claim 1, wherein the pretensioning mechanism is actuated by one of pyrotechnics, an electric motor, a solenoid, or a combination thereof.

10. The vehicle occupant protection system of claim 1, wherein the pretensioning mechanism is one of a linear piston retractor, a rotational retractor, and a linear rack and pinion retractor.

11. The vehicle occupant protection system of claim 1, wherein the tension element is a tether.

12. The vehicle occupant protection system of claim 1, wherein the inflatable airbag cushion is configured to be deployed from one of a vehicle roof, a header, a headliner, and a vehicle occupant seat.

13. The vehicle occupant protection system of claim 1, further comprising a load limiting mechanism coupled to the pretensioning mechanism.

14. The vehicle occupant protection system of claim 1, wherein the pretensioning mechanism comprises a load limiting mechanism.

15. The vehicle occupant protection system of claim 13, wherein the load limiting mechanism comprises at least one torsion bar.

16. The vehicle occupant protection system of claim 13, wherein the load limiting mechanism comprises a piston.

17. The vehicle occupant protection system of claim 13, wherein the load limiting mechanism is a digressive functioning component.

18. The vehicle occupant protection system of claim 13, wherein the load limiting mechanism is an adaptive functioning component.

19. The vehicle occupant protection system of claim 13, wherein the load limiting mechanism is configured to limit a tension load on the tension element following deployment of the inflatable airbag cushion and upon occupant loading.

20. The vehicle occupant protection system of claim 13, wherein the load limiting mechanism is configured to permit load limited forward displacement of the inflatable airbag cushion following deployment of the inflatable airbag cushion.

21. An airbag assembly, comprising:
an inflatable airbag cushion to receive inflation gas to deploy the inflatable airbag cushion forward of a vehicle seating position;
a tension element comprising a first end secured to the inflatable airbag cushion and a second end;
a first mechanism coupled to the second end of the tension element, wherein the first mechanism is configured to be secured to a vehicle structure and to apply a rearward force to the tension element following at least partial deployment of the inflatable airbag cushion; and
a second mechanism coupled to the second end of the tension element, wherein the second mechanism is configured to permit load limited forward displacement of the inflatable airbag cushion following deployment of the inflatable airbag cushion.

22. The airbag assembly of claim 21, wherein the first mechanism and the second mechanism are integrated.

23. The airbag assembly of claim 21, wherein the rearward force applied to the tension element is to retain an occupant in a vehicle seating position by the inflatable airbag cushion.

24. The airbag assembly of claim 21, wherein the rearward force applied to the tension element is to optimize ride down kinematics of an occupant upon impact with the inflatable airbag cushion.
